(19) United States
(12) Patent Application Publication
(10) Pub. No.: US 2008/0298005 A1
(43) Pub. Date: Dec. 4, 2008

(54) MOUNTING APPARATUS FOR STORAGE DEVICE

(75) Inventors: SONG DENG, Shenzhen (CN); WEN-KANG LO, Tu-Cheng (TW); HSUAN-TSUNG CHEN, Tu-Cheng (TW); GUANG-YAO LEE, Tu-Cheng (TW); CHUN-CHI LIANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/934,787

(22) Filed: Nov. 5, 2007

(30) Foreign Application Priority Data
Jun. 1, 2007 (CN) 200710200747.1

(51) Int. Cl. G06F 1/16

(52) U.S. Cl. 361/684

(57) ABSTRACT

A mounting apparatus includes a bracket, a frame for receiving a storage device, and a fixing member mounted on the frame for fixing the storage device to the frame. The bracket includes two sidewalls each forming two inward bent sliding rails. The frame includes two elastic arms, and each of the elastic arms forms two spaced strip-shaped flanges slidably receivable between the sliding rails of a corresponding sidewall of the bracket. Two elastic bent portions are formed on the flanges of each of the elastic arms respectively. The elastic bent portions are bent away from each other and capable of being deformed and received between the sliding rails of the corresponding sidewall.

### BACKGROUND

1. Field of the Invention

The present invention relates to mounting apparatuses, and more particularly to a mounting apparatus for a storage device.

2. Description of Related Art

An electronic apparatus, such as a typical desktop computer, tower computer, server, or the like, usually includes storage devices, such as hard disk drives, compact disk read-only memory (CD-ROM) drives, digital video disc (DVD) drives, floppy disk drives, and the like. These devices are typically added to increase the functionality of the electronic apparatus as desired by a user. However, the installation of such devices in the electronic apparatus is labor-intensive.

The installation of a hard disk drive in a computer typically involves the use of screws to attach the hard disk drive to a bracket of a computer chassis. However, these screws are usually too small and difficult to handle. Additionally, because of their small size, the screws are easily dropped, by an assembler, into the computer.

To address the aforementioned problems, a plurality of mounting apparatuses is invented to reduce the number of needed screws. For example, a pair of detachable rails is attached to opposite sides of a storage device with screws. The storage device is then slid into and secured to a drive bracket. However, because the screws are directly engaged in the rails and the storage device, the storage device is apt to be damaged by vibration transmitted through the screws.

What is needed, therefore, is a mounting apparatus which is able to provide better protection to a storage device.

### SUMMARY

An exemplary mounting apparatus includes a bracket, a frame for receiving a storage device, and a fixing member mounted on the frame for fixing the storage device to the frame. The bracket includes two sidewalls each forming two inward bent sliding rails. The frame includes two elastic arms, and each of the elastic arms forms two spaced strip-shaped flanges slidably receivable between the sliding rails of a corresponding sidewall of the bracket. Two elastic bent portions are formed on the flanges of each of the elastic arms respectively. The elastic bent portions are bent away from each other and capable of being deformed and received between the sliding rails of the corresponding sidewall.

Other advantages and novel features will become more apparent from the following detailed description of embodiment when taken in conjunction with the accompanying drawings, in which:

### BRIEF DESCRIPTION OF THE DRAWINGS

FIG. 1 is an exploded, isometric view of a mounting apparatus with a storage device in accordance with an embodiment of the present invention, the mounting apparatus includes a bracket;

FIG. 2 is a partially cut-away view of the bracket of FIG. 1, but viewed from another aspect;

FIG. 3 is a partially assembled view of FIG. 1 without the bracket; and

FIG. 4 is an assembled view of FIG. 1.

### DETAILED DESCRIPTION

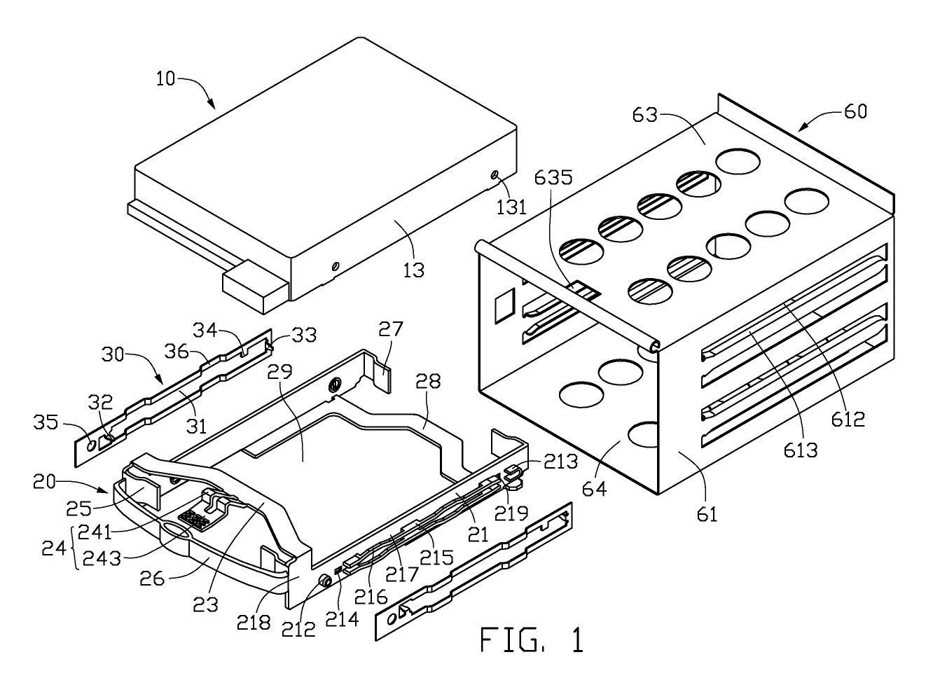

Referring to FIG. 1, a mounting apparatus for a storage device is provided in accordance with an embodiment of the present invention. The mounting apparatus includes a frame 20 for receiving a storage device 10, two fixing members 30, and a bracket 60.

The storage device 10 includes two opposite lateral sides 13, and each lateral side 13 defines two spaced fixing holes 131 therein.

The frame 20 is made of plastic material. The frame 20 includes two opposite elastic arms 21 each having a first end and a second end, and a handle connecting with the first ends of the elastic arms 21. Each elastic arm 21 forms a post 212, and a generally U-shaped protrusion 213 on an outside surface thereof adjacent to the first end, and the second end respectively. The closed end of each protrusion 213 is toward the second end of the corresponding elastic arm 21. Two through holes 214, 219 are defined in each elastic arm 21, corresponding to the fixing holes 131 of the storage device 10. The outside surface of each elastic arm 21 forms two spaced strip-shaped flanges 215 between the through holes 214, 219 thereof, parallel to the top and bottom edges of the elastic arm 21. Two spaced slots 217 are defined between each flange 215 and the corresponding elastic arm 21. Each flange 215 forms two elastic bent portions 216 adjacent to the slots 217 respectively. The elastic bent portions 216 of each flange 215 are bent away from the adjacent flange 215 on the same elastic arm 21. An extending portion 218 extends upward from the first end of each elastic arm 21. A connecting portion 23 is formed on the top of the frame 20 with two ends connecting with tops of the extending portions 218 of the elastic arms 21 respectively. A latch 24 extends from the middle section of the connecting portion 23 toward the handle 26. The latch 24 includes two spaced upward bent latching portions 241, and a pressing portion 243 extending from free ends of the latching portions 241 toward the handle 26 for controlling the latching portions 241 up and down. Each latching portion 241 forms a slanted surface toward the connecting portion 23. Stop plates 25, 27 extend perpendicularly from the first and second ends of each elastic arm 21 respectively toward the opposite elastic arm 21. A supporting portion 28 is formed on the bottom of the frame 20 between the elastic arms 21 for supporting the storage device 10. A receiving space 29 is defined between the supporting portion 28, the connecting portion 23, the elastic arms 21, and the stop plates 25, 27 of the elastic arms 21.

Each fixing member 30 defines an elongate slot 31. Pins 32, 33 are perpendicularly formed on each fixing member 30 respectively adjoining two ends of the elongate slot 31. An upper portion above the elongate slot 31 and a bottom portion below the elongate slot 31 of each fixing member 30 each form two spaced outward bent bridges 36. A fixing tab 34 extends perpendicularly from the upper portion of each fixing member 30 in the corresponding elongate slot 31. A bore 35 is defined in each fixing member 30 adjacent to an end thereof.

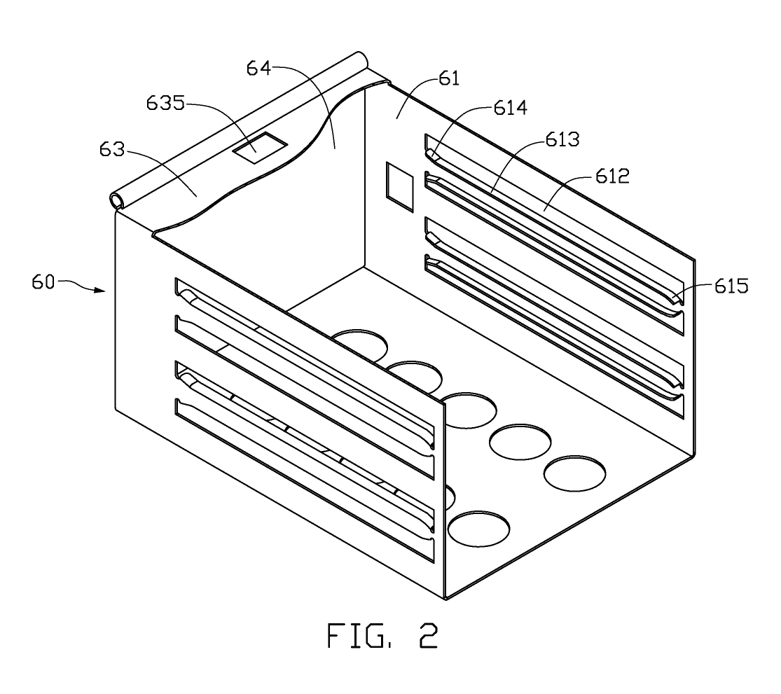

Referring also to FIG. 2, the bracket 60 includes a top wall 63, and two sidewalls 61. An opening 64 is defined in one end of the bracket 60 between the sidewalls 61. An engaging slot 635 is defined in the top wall 63 adjacent to the opening 64 of the bracket 60. Two sliding slots 612 are punched in each sidewall 61 parallel to the top wall 63, and two inward bent sliding rails 613 are formed on each sidewall 61 between the sliding slots 612. Each sliding rail 613 includes a main body parallel to the top wall 63. The sliding rails 613 of each sidewall 61 respectively form slanted portions 614 bent away from each other on ends of the main bodies adjacent to the opening 64, and respectively form arcuate stop portions 615 bent toward each other on opposite ends of the main bodies away from the opening 64.

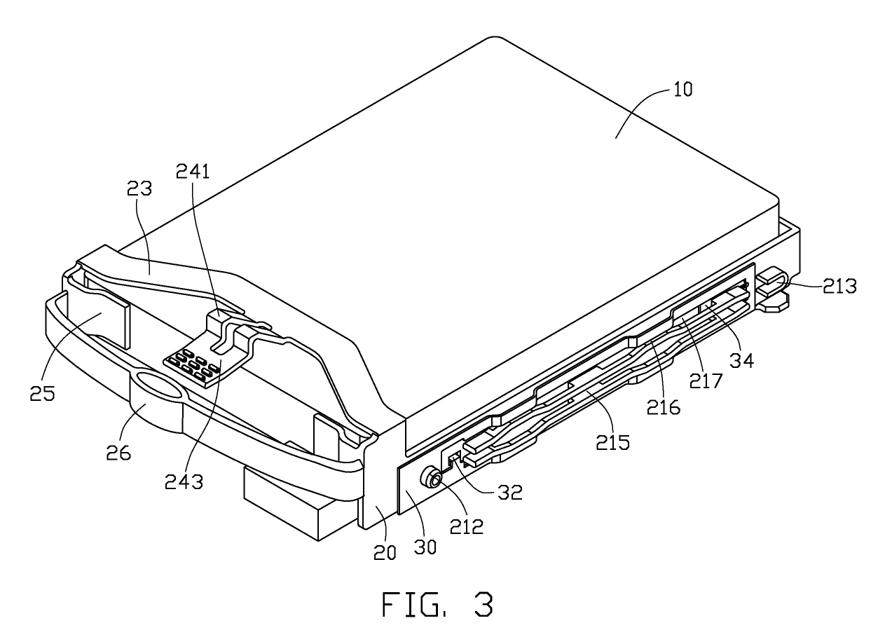

Referring further to FIG. 3, in assembly, the fixing members 30 are fixed to the elastic arms 21 of the frame 20 respectively, with the fixing tab 34 of each fixing member 30 engaging in the corresponding slot 217 of the corresponding elastic arm 21, the flanges 215 and the post 212 of each elastic arm 21 extending through the elongate slot 31 and the bore 35 of the corresponding fixing member 30 respectively, and the pins 32, 33 of each fixing member 30 extending through the through holes 214, 219 of the corresponding elastic arm 21 respectively. The elastic arms 21 of the frame 20 deform outward away from each other to allow the storage device 10 to be received in the frame 20 and supported on the supporting portion 28. Two ends of the storage device 10 engage with the stop plates 25, 27 of the frame 20 respectively, and the fixing holes 131 of the lateral sides 13 of the storage device 10 align with the pins 32, 33 of the fixing members 30 respectively. Thereafter, the elastic arms 21 are released and rebound, causing the pins 32, 33 to engage in the corresponding fixing holes 131 of the lateral sides 13 of the storage device 10. Thereby, the storage device 10 is fixed in the frame 20.

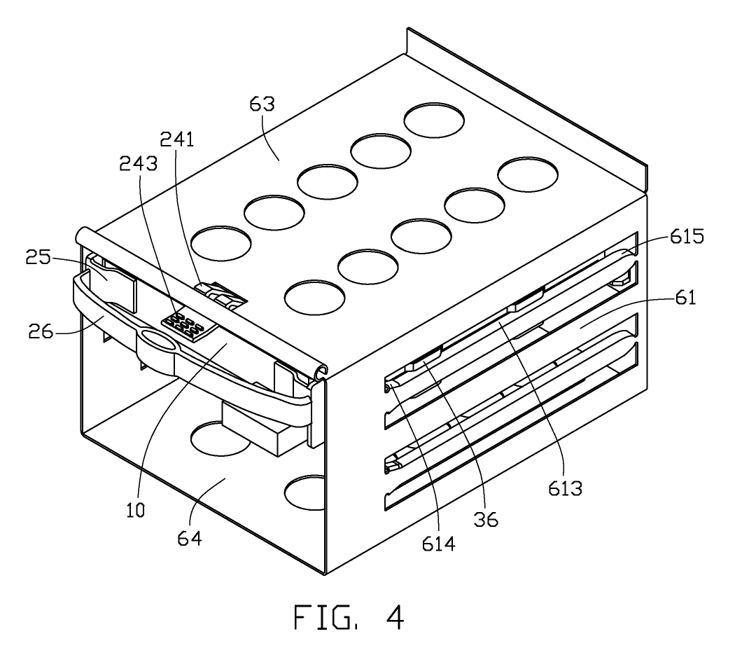

Referring further to FIG. 4, the frame 20 together with the storage device 10 are pushed to slide into the bracket 60 from the opening 64, with the protrusion 213 and the flanges 215 of each elastic arm 21 of the frame 20 slidably received between the sliding rails 613 of the corresponding sidewall 61 of the bracket 60. When the elastic bent portions 216 of the flanges 215 of each elastic arm 21 pass through the slanted portions 614 and then abut against the main bodies of the corresponding sliding rails 613, the elastic bent portions 216 of each elastic arm 21 deform to be slidably received between the corresponding sliding rails 613. The bridges 36 of each fixing member 30 mounted on the frame 20 are slidably received in the corresponding sliding slots 612 of corresponding sidewall 61. The frame 20 is slid until the slanted surface of the latch 24 of the connecting portion 23 abuts against the top wall 63 of the bracket 60. Then the frame 20 is pushed further, the latching portions 241 of the latch 24 deform downward and enter the bracket 60. When the closed ends of the protrusions 213 of the elastic arms 21 abut against the arcuate stop portions 615 of the sliding rails 613 of the corresponding sidewalls 61, the latching portions 241 of the latch 24 are restored to engage in the engaging slot 635 of the top wall 63. Thereby, the frame 20 and the storage device 10 are fixed to the bracket 60 in a locked position, with the handle 26 and the pressing portion 243 of the latch 24 being left outside of the opening 64 of the bracket 60. In this process, the slanted portions 614 of the sliding rails 613 of each sidewall 61 assists the protrusion 213 and flanges 215 of the corresponding elastic arm 21 of the frame 20 to slide into the sliding rails 613. The elastic bent portions 216 of the elastic arms 21 of the frame 20 are deformed, and are received between the sliding rails 613 of the corresponding sidewalls 61 of the bracket 60, which is able to protect the storage device 10 from vibrations.

To detach the storage device 10, the pressing portion 243 of the latch 24 is pressed down, to make the latching portions 241 of the latch 24 disengage from the engaging slot 635 of the top wall 63 of the bracket 60. At the same time, the handle of the frame 20 is pulled outward from the opening 64 of the bracket 60, then the frame 20 and the storage device 10 are pulled out of the bracket 60. Thereafter, the elastic arms 21 of the frame 20 deform away from each other, to disengage the pins 32, 33 of the fixing members 30 from the fixing holes 131 of the storage device 10 respectively. Thereby, the storage device 10 is ready to be detached from the frame 20.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A mounting apparatus for a storage device, the mounting apparatus comprising:
a bracket comprising two sidewalls each forming two inward bent sliding rails;
a frame for receiving the storage device, the frame comprising two elastic arms, each of the elastic arms forming two spaced strip-shaped flanges slidably receivable between the sliding rails of a corresponding sidewall of the bracket, two elastic bent portions formed on the flanges of each of the elastic arms respectively, the elastic bent portions bent away from each other and capable of being deformed and received between the sliding rails of the corresponding sidewall, at least one of the elastic bent portions constantly engaging with a corresponding sliding rail when no vibration happens; and
at least one fixing member mounted on the frame for fixing the storage device to the frame.

2. The mounting apparatus as claimed in claim 1, wherein a slot is defined between the elastic bent portion of each of the flanges and a corresponding elastic arm.

3. The mounting apparatus as claimed in claim 2, wherein the fixing member defines an elongate slot allowing the flanges of the corresponding elastic arm to extend therethrough, a fixing tab extends perpendicularly down from the fixing member toward the elongate slot for engaging in the slot between the corresponding elastic arm and flange.

4. The mounting apparatus as claimed in claim 1, wherein one of the elastic arms defines a through hole, and the fixing member forms a pin for extending through the through hole of said one of the elastic arms and latching the storage device.

5. The mounting apparatus as claimed in claim 4, wherein the fixing member defines a bore therein, and said one of the elastic arms forms a post on an outside surface thereof for extending through the bore of the fixing member.

6. The mounting apparatus as claimed in claim 1, wherein the bracket further comprises a top wall, the top wall defines an engaging slot adjacent to an end thereof, a connecting portion is formed on the top of the frame, a latch extends from the connecting portion for engaging in the engaging slot of the top wall of the bracket.

7. The mounting apparatus as claimed in claim 6, wherein the latch comprises an upward bent latching portion for engaging in the engaging slot of the top wall of the bracket, and a pressing portion extending from a free end of the latching portion for disengaging the latch from the top wall of the bracket.

8. The mounting apparatus as claimed in claim 1, wherein a supporting portion is formed on the bottom of the frame, two stop plates extend from two ends of each of the elastic arms respectively, the supporting portion and the stop plates cooperatively form a receiving space for receiving the storage device.

9. The mounting apparatus as claimed in claim 1, wherein a handle is formed on one end of the frame with two ends connecting with the elastic arms respectively.

10. The mounting apparatus as claimed in claim 9, wherein a generally U-shaped protrusion is formed on each of the elastic arms away from the handle, the protrusions are slidably receivable between the sliding rails of the corresponding sidewalls, the sliding rails of each of the sidewalls respectively form stop portions toward each other adjacent to an end thereof, for abutting against the protrusion of the corresponding elastic arm when the frame is received in the bracket.

11. The mounting apparatus as claimed in claim 1, wherein the bracket defines an opening between the sidewalls for allowing the frame to be insert into the bracket therefrom, the sliding rails of each of the sidewalls respectively from slanted portions away from each other on ends adjacent to the opening.

12. A mounting apparatus for a storage device, the mounting apparatus comprising:
a bracket comprising two sidewalls each forming two inward bent sliding rails; and
a frame comprising two elastic arms, and a receiving space defined between the elastic arms for receiving the storage device, each of the elastic arms forming two spaced strip-shaped flanges slidably receivable between the sliding rails of a corresponding sidewall of the bracket, at least one slot defined between each of the flanges and a corresponding elastic arm, each of the flanges forming an elastic bent portion adjacent to the corresponding slot, the elastic bent portions of the flanges of each of the elastic arms bent away from each other and capable of being deformed and abuttingly received between the sliding rails of the corresponding sidewall.

13. The mounting apparatus as claimed in claim 12, wherein a supporting portion is formed on the bottom of the frame, two stop plates extend from two ends of each of the elastic arms respectively, a connecting portion is formed on the top of the frame, the receiving space is defined between the supporting portion, the connecting portion, the elastic arms, and the stop plates.

14. The mounting apparatus as claimed in claim 13, wherein the bracket further comprises a top wall, the top wall defines an engaging slot adjacent to an end thereof, a latch extends from the connecting portion of the frame for engaging in the engaging slot of the top wall of the bracket.

15. The mounting apparatus as claimed in claim 12, further comprising two fixing members mounted on the elastic arms of the frame respectively, each of the elastic arms defining at least one through hole therein, and each of the fixing members forming at least one pin for extending through the through hole of a corresponding elastic arm and engaging with the storage device.

16. The mounting apparatus as claimed in claim 15, wherein each of the sidewalls defines two sliding slots adjoining to the sliding rails respectively, each of the fixing members defines an elongate slot to allow the flanges of the corresponding elastic arm to extend therethrough, and forms an upper portion above the elongate slot and a bottom portion below the elongate slot, each of the upper portion and the bottom portion forms two spaced outward bent bridges for being slidably received in a corresponding sliding slot of the corresponding sidewall of the bracket.
